(19) United States
(12) Patent Application Publication
(10) Pub. No.: US 2007/0038351 A1
(43) Pub. Date: Feb. 15, 2007

(54) Driver activity and vehicle operation logging and reporting

(76) Inventors: Bradley R. Larschan, Germantown, TN (US); Alan C. Lesesky, Charlotte, NC (US); J. Richard Bishop JR., Woodstock, MD (US); James W. Welch, Germantown, TN (US)

Correspondence Address: FISH & RICHARDSON P.C., P.O. BOX 1022, MINNEAPOLIS, MN, 55440-1022, US

(21) Appl. No.: 11/352,396

(22) Filed: Feb. 13, 2006

Related U.S. Application Data
(63) Continuation-in-part of application No. 11/203,280, filed on Aug. 15, 2005, now Pat. No. 7,117,075.

(51) Int. Cl. G01M 17/00

(52) U.S. Cl. 701/35; 701/29

(57) ABSTRACT

A method for logging and reporting driver activity and vehicle operation includes identifying a driver of a vehicle, recording operating data with an on-board recorder that is hard-wired to an engine control module, coupled to a mileage sensing system, and linked to a global navigation satellite system, and recording duty status of the driver. An hours of service log and a fuel tax log are created from the operating data. The method includes comparing the driver's hours of service log to an applicable requirement, indicating to the driver whether the driver is in-compliance or out-of-compliance with the applicable governmental reporting requirement, automatically uploading the logs to a receiver external to the vehicle using a wireless telecommunications network, and emitting a compliance signal representative of whether the driver is in-compliance or out-of-compliance with the applicable requirement to a second receiver external to the vehicle and under control of authorities.

### CROSS-REFERENCE TO RELATED APPLICATIONS

This application is a continuation-in-part application of, and claims priority under 35 U.S.C. § 120 to, U.S. patent application Ser. No. 11/203,280, filed on Aug. 15, 2005 and entitled “Driver Activity and Vehicle Operation Logging and Reporting,” the entirety of which is incorporated by reference.

### TECHNICAL FIELD

The invention relates to driver activity and vehicle operation logging and reporting.

### BACKGROUND

One of the largest government-mandated paperwork and cost burdens imposed upon any segment of private industry are the reporting requirements relating to commercial motor vehicles (CMV). Commercial Motor Vehicles (CMV) and their respective drivers and carriers are required by various federal regulations and international agreements to comply with rules governing the safe operation of the vehicles and the reporting of fuel taxes. In 1937, the federal government imposed hours-of-service (HOS) regulations upon commercial motor vehicle drivers operating commercial vehicles in the domestic motor carrier industry to ensure highway safety. Under direction of Congress, the Federal Motor Carrier Safety Administration (FMCSA) has scrutinized and periodically revised the hours-of-service regulations to aid in the reduction of driver fatigue and sleep disorder related incidents on the nation's highways.

Federal regulations relating to the safe operation of Commercial Motor Vehicles (CMV) are defined in 49 CFR Part 395 and 49 CFR Part 390.2&.15, the entirety of each of which are incorporated by reference. One way in which safety is promoted in the hours-of-service regulations is to prohibit drivers from operating or being forced to operate their vehicles more than a specified amount of time between mandatory off-duty periods. In 1987, the FMCSA permitted carriers the flexibility of using an automatic on-board recording device (AOBRD) instead of the traditional reporting method involving manual data entry and filing of reports by the CMV drivers and/or their carriers.

The International Fuel Tax Agreement (IFTA) is an agreement among jurisdictions in the United States, Mexico and Canada that simplifies the reporting of fuel-use tax for diesel, gasoline, gasohol, propane, and natural gas consumption by commercial motor vehicles. Fuel-use tax is included in the purchase price of the fuel and then later redistributed to those jurisdictions where the vehicle actually was driven while consuming fuel. For example, a driver of a CMV may purchase diesel fuel in the state of Texas and travel outside of Texas to a neighboring state, e.g., Louisiana, using the same diesel fuel purchased in Texas. IFTA requires carriers to report actual mileage driven in each jurisdiction so that the actual taxes collected may be later apportioned to Texas and Louisiana in accordance with actual vehicle operation.

Each day, some 6.4 million drivers complete HOS logs to track driver compliance with HOS regulations. In addition, fuel tax logs are created daily for some 10 million trucks. The cost of compliance with these reporting requirements is extraordinarily burdensome. It is estimated that the annual cost of complying with reporting requirements using paper logs is approximately $2,000.00 per driver and $2,000.00 per commercial motor vehicle. This results in a paper log compliance cost of $31 billion dollars per year imposed upon private industry.

### SUMMARY

In one aspect, a method for logging and reporting driver activity and vehicle operation includes identifying a driver of a vehicle and recording operating data. The operating data is recorded with an on-board recorder that is hard-wired to a data bus, for example, an engine control module, of the vehicle, coupled to a vehicle mileage sensing system, and linked to a global navigation satellite system. The operating data includes mileage obtained from at least one of the vehicle mileage sensing system and the vehicle data bus; engine use, time, and date obtained from the vehicle data bus; and location, time, and date obtained from the global navigation satellite system. The method includes recording a duty status of the driver. The duty status includes (a) off duty status, (b) sleeper berth status, (c) driving-on duty status, and (d) not driving-on duty status.

The method further includes creating an hours of service log from time, date, and duty status, the hours of service log including a change in duty status of the driver, time and date the change occurred, hours within each duty status, total hours driven today, total hours on duty for seven days, and total hours on duty for eight days; creating a fuel tax log from mileage obtained from the vehicle mileage sensing system, location obtained from the global navigation satellite system, time obtained from at least one of the vehicle data bus and the global navigation satellite system, and date obtained from at least one of the vehicle data bus and the global navigation satellite system, the fuel tax log including miles traveled between periodic recording intervals, and location, time, and date recorded at each periodic recording interval; comparing the driver's hours of service log to an applicable requirement, for example, law or regulation; indicating to the driver with the on-board recorder whether the driver is in-compliance or out-of-compliance with the applicable requirement; automatically uploading the hours of service log and the fuel tax log to a receiver external to the vehicle using a wireless telecommunications network; and emitting a compliance signal representative of whether the driver is in-compliance or out-of-compliance with the applicable requirement to a second receiver external to the vehicle and under control of authorities.

Embodiments of this aspect may include one or more of the following features.

The method includes identifying the driver of the vehicle by interfacing with a portable memory device, and importing a driver's hours of service log through the portable memory device or the wireless network. The portable memory device is, for example, a smart card or contact memory button. The method further includes verifying the identity of the driver of the vehicle using, for example, biometric verification, and enabling the vehicle to be started, moved, or engine idled in response to identifying the driver of the vehicle.

Recording operating data includes automatically recording the mileage from the vehicle mileage sensing system; the mileage, engine use, time, and date obtained from the vehicle data bus; and the location, time, and date obtained from the global navigation satellite system. Recording the duty status can include automatically determining a change in the duty status and at least one of the time, date and location of the change in the duty status from the operating data. Recording the duty status includes logging a change in the duty status from a manual input by the driver.

The fuel tax log is used to create an IFTA (International Fuel Tax Agreement) compliant fuel tax report. The method includes automatically or manually inputting an indication of a border crossing.

When team driving, the method includes logging the duty status of a first driver of the vehicle with the on-board recorder; identifying a next driver of the vehicle with the on-board recorder; logging the duty status of the first driver and the next driver of the vehicle with the on-board recorder; and importing data for an hours of service log for the next driver into the on-board recorder from at least one of a portable memory device and a wireless telecommunications network. The fuel tax log can be created for a single vehicle having the first driver and the second driver.

The method includes calibrating mileage received from the vehicle mileage sensing system using data received from the global navigation satellite system or using vehicle tire size, and providing mileage from the recorder to an odometer display and to the vehicle data bus.

An exceptions report can be created from the comparison of the driver's hours of service log to the applicable requirement, and a cause of being out-of-compliance displayed to the driver, fleet managers or law enforcement.

The method includes encrypting the operating data, the hours of service log, the fuel tax log, and the compliance signal emitted from the recorder to ensure data integrity.

Operating data, which includes hours of service, fuel purchase, fuel tax, vehicle and driver related data, can be modified by a driver input and/or by a fleet carrier input, and any alterations of operating data recorded with a track changes function of the on-board recorder and/or on the host server.

The hours of service log can be displayed, for example, inside or outside the vehicle on an external display, as a graphical grid.

Automatically uploading includes uploading over a pager connection, a cellular telephone connection, a wide area network connection, an infrared connection, a radio connection, and/or a satellite connection. Automatically uploading includes uploading during an off-peak operating period, for example between 1:00 am and 5:00 am and/or on a weekend, for a wireless telecommunications network. Automatically uploading includes attempting to upload at least daily first over a least expensive connection and, if unsuccessful, then over at least one next least expensive connection, and uploading over a satellite connection when successive daily uploads are unsuccessful. Automatically uploading includes attempting to upload at least daily first over a predetermined wireless telecommunications network connection and, if unsuccessful, then over another predetermined wireless telecommunications network. Automatic uploading is an uploading of the current day, previous days, or day prior to the previous day hours of service and/or fuel tax logs.

The method includes uploading to the second receiver external to the vehicle when a compliance status check is requested by law enforcement, and/or when the vehicle is within a predetermined range of the second receiver. The second receiver is located, for example, on a handheld device, along a highway, at a weigh station, or within a law enforcement vehicle. The compliance signal is uploaded, for example, through a wired or wireless connection connected to a data port inside or outside of the vehicle.

The hours of service log is output to, for example, a display on the on-board recorder, a display on an external display device, the second receiver, or a wired connection connected to a data port inside or outside of the vehicle. The output of the hours of service log occurs responsive to a request from, for example, the driver, a fleet carrier, or the authorities. A data transfer and storage device can be placed in communication with the on-board recorder; and the hours of service log, fuel tax log, and the compliance signal uploaded to the data transfer and storage device.

The receiver to which the logs are automatically uploaded is, for example, a host server, and the fuel tax logs are uploaded from the host server to an external server that creates and files fuel tax reports.

In particular embodiments, the method may include notifying the driver if a particular event occurs, for example, notifying the driver to log into the recorder if the vehicle moves and the driver has not logged in, emitting an out-of-compliance signal if the driver is not logged in within a predetermined period, notifying the driver to log operating data on a paper log if the recorder is malfunctioning, and notifying a driver when the driver is nearing the end of an hours of service parameter. The driver can be notified by, for example, a text message, a visual indicator, and/or an audible signal. Compliance can be indicated by red, yellow, and green lights. A light on the recorder can be flashed when the driver is within a first predetermined time period of the end of the parameter, and another light on the recorder flashed when the driver is within another predetermined time period of the end of the parameter. The carrier can also be notified when the driver is nearing the end of a parameter.

The method further includes, for example, the driver certifying the hours of service log prior to the automatic upload, or initiating a self-diagnostic function on the recorder upon a predetermined event. The predetermined event is at least one of a vehicle start, once in a 24-hour cycle, upon demand by law enforcement, and upon demand by the driver.

According to another aspect, a method for logging and reporting driver activity and vehicle operation includes recording only the following operating data mileage obtained from at least one of the vehicle mileage sensing system and the vehicle data bus; engine use, time, and date obtained from the vehicle data bus; and location, time, and date obtained from the global navigation satellite system.

According to another aspect, an on-board recorder for logging and reporting driver activity and vehicle operation includes a memory device configured to store operating data; a power supply; a first interface configured to connect to a vehicle mileage sensing system; a second interface configured to connect to an vehicle data bus of the vehicle; a receiver configured to link with a global navigation satellite system; at least one data portal configured to upload data from the memory device to a receiver external to the vehicle using a wireless telecommunications network, and supporting a connection with a receiver external to the vehicle and under control of authorities; a driver interface configured to record driver identification information input by a driver of the vehicle and duty status input by the driver; a processor operatively connected to the memory device for processing encoded instructions, recording operating data, and creating an hours of service log, a fuel tax log, and determining whether the driver is in compliance with an applicable requirement; and a display.

According to another aspect, a system for logging and reporting driver activity and vehicle operation includes an on-board recorder; wired connection between the on-board recorder and the vehicle data bus; a first server connected with the vehicle through the wireless telecommunications network, the on-board recorder being configured to automatically download the hours of service log, the fuel tax log, and the compliance signal; and a second server connected with the first server and configured to receive the fuel tax log, the second server including a computer readable media encoded with one or more computer programs for filing fuel tax reports based on the fuel tax log.

According to another aspect, a device for logging and reporting driver activity and vehicle operation includes one or more of the following means: means for identifying a driver of a vehicle and recording operating data; means for recording a duty status of the driver; means for creating an hours of service log; means for creating a fuel tax log; means for comparing the driver's hours of service log to an applicable requirement; means for indicating to the driver with the on-board recorder whether the driver is in-compliance or out-of-compliance with the applicable requirement; means for automatically uploading the hours of service log and the fuel tax log to a receiver external to the vehicle; and means for emitting a compliance signal representative of whether the driver is in-compliance or out-of-compliance with the applicable governmental reporting requirement to a second receiver external to the vehicle and under control of authorities.

According to another aspect, a method includes one or more of the following and/or an apparatus includes one or more of the following means for: identifying one or more drivers of a vehicle; verifying the identity of the one or more drivers by at least one of biometric and visual means; determining driver hours of service for more than one driver concurrently; recording driver hours of service for more than one driver concurrently; uploading data via a least cost method over a wireless telecommunications network; uploading through the recorder, via a wireless telecommunications network, driver identity, whether or not verified; identifying a driver, tying identity information to a driver record, determining driver hours of service, recording hours of service, uploading hours of service via a wireless telecommunications network, and optionally verifying identity information and optionally tying verification information to the driver record.

According to another aspect, a method includes one or more of the following and/or an apparatus includes one or more of the following means for: determining miles driven by a vehicle; recording miles driven by a vehicle; determining at least one of present and past location of a vehicle within a jurisdiction; determining at least one of present and past location of a vehicle between jurisdictions; determining border crossings between jurisdictions; recording at least one of present and past location of a vehicle within a jurisdiction; recording at least one of present and past location of a vehicle within two or more jurisdictions; recording border crossings between jurisdictions; uploading via a wireless telecommunications network at least one of present and past location of a vehicle within a jurisdiction; uploading via a wireless telecommunications network at least one of present and past location of a vehicle within two or more jurisdictions; uploading via a wireless telecommunications network border crossings between jurisdictions; and uploading via a least cost method over a wireless telecommunications network at least one of present and past location of a vehicle within a jurisdiction, at least one of present and past location of a vehicle within two or more jurisdictions, and/or border crossings between jurisdictions.

According to another aspect, a method includes one or more of the following and/or an apparatus includes one or more of the following means for: calculating, for example, periodically, when interrogated by authorities, or continuously, whether or not a driver is driving within parameters established by at least one of law(s) or regulation(s); wirelessly notifying, signaling, alerting or informing authorities that a driver is not in compliance with applicable hours of service laws or regulations; transmitting driver hours of service data to law enforcement via at least one of a wired connection, portable memory device and wirelessly; displaying data residing on the recorder via at least one of a wired connection, portable memory device and wirelessly; displaying remaining time for driver hours of service in at least one duty status generated from the recorder; exchanging data between the recorder and devices used to pump fuel into a vehicle; determining a driver's hours of service in compliance with home country and country of operation laws and regulations determining more than one driver's hours of service concurrently in compliance with home country and country of operation laws and regulations; and displaying hours of service data in any one or more languages.

According to another aspect, a method includes one or more of the following and/or an apparatus includes one or more of the following means for identifying the location at which a trailer is at least one of tethered or un-tethered from a vehicle; recording the location at which a trailer is at least one of tethered or un-tethered from a vehicle; uploading the location at which a trailer is at least one of tethered or un-tethered from a vehicle; identifying the location of a trailer tethered to a vehicle; recording the location of a trailer tethered to a vehicle; and uploading the location of a trailer tethered to a vehicle.

According to another aspect, a least cost method of uploading driver hours of service data includes determining, with an on-board recorder, available data transmission options; and uploading driver hours of service data via a wireless network with a least cost data transmission option.

According to another aspect, a least cost method of uploading driver hours of service data includes electronically determining, such as with an onboard recorder or remotely at a fleet server, available data transmission options and an associated transmission cost for each data transmission option. Driver hours of service data is uploaded via a wireless network supporting the least cost data transmission option, e.g., transmitting 1.2 MB of data at 2:45 a.m. EST from interstate 81 in eastern Pennsylvania through a cellular telephone network.

According to another aspect, a least cost method of uploading driver hours of service data includes determining at least three available data transmission options for a vehicle on-board recorder and an associated cost for each available data transmission option. Driver hours of service data is uploaded from the vehicle on-board recorder via a wireless network using the least cost data transmission option.

According to another aspect, a least cost method of uploading vehicle location data includes determining, with an on-board recorder, available data transmission options, and uploading vehicle location data via a wireless network with a least cost data transmission option.

According to another aspect, a least cost method of uploading driver hours of service data includes electronically determining available data transmission options and an associated transmission cost for each data transmission option. The driver hours of service data is uploaded via a wireless network with the least cost data transmission option.

Embodiments of these least cost methods may include one or more of the following features.

Determining available data transmission options includes identifying available data transmission time periods and/or available wireless networks, such as pager networks, cellular telephone networks, wide area networks, infrared communication networks, radio networks, and/or satellite network. Determining available data transmission options includes identifying multiple available data transmission options, such as three or more available data transmission options, and selecting the least cost data transmission option based on pricing schedules stored in memory of an onboard recorder or remotely at a fleet server. The location or geolocation of the data transmission, date and time of data transmission, and/or data content are parameters relating to a determination of the least cost data transmission option.

The method can include electronically determining available data transmission options using a fleet server to determine available methods or associated costs, and downloading pricing plan(s) for available options to a vehicle on-board recorder. Alternatively, or in combination, electronically determining available data transmission options with the vehicle on-board recorder includes stored pricing plans based on one or more of geolocation, location, date and time of transmission, data transmission rate and/or data content.

According to another aspect, a method includes identifying a driver in a vehicle with an on-board recorder recording at least one of hours of service for a driver and fuel tax reporting data for the vehicle. The driver is tied to a driver record, such as data stored within a memory of the on-board recorder or a fleet server and relating to one or more of commercial driver licenses, driver history, driver identification and physical descriptions of the driver using the on-board recorder.

According to another aspect, a method includes obtaining a biometric of a driver of a vehicle using an on-board recorder, and recording at least one of hours of service data and fuel tax reporting data on the on-board recorder.

According to another aspect, a method includes using an on-board recorder of a vehicle to automatically obtain a biometric of a driver of the vehicle.

Embodiments of these methods for obtaining a biometric of a driver may include one or more of the following features.

The method includes logging the driver into the on-board recorder, e.g., before, after or while obtaining the biometric and before recording hours of service data and/or fuel tax reporting data. The method includes verifying the biometric of the driver with a reference biometric of the driver, e.g., a reference biometric of the driver stored on the on-board recorder, a portable memory device and/or on a server remote from the on-board recorder.

The biometric of the driver is obtained periodically, randomly, or responsive to a predetermined event, e.g., manually initiated, upon switching drivers, responsive to change in duty status or change in operating state of the vehicle or engine. The biometric is stored on the on the on-board recorder, and/or uploaded from the on-board recorder through an external network. A cargo associated with the vehicle is identified, and the on-board recorder is used to automatically obtain the biometric occurs responsive to identifying the cargo associated with the vehicle. The cargo is a specific cargo type, such as a hazardous material.

The method includes logging the driver into the on-board recorder, and using the on-board recorder to obtain the biometric of the driver occurs before, during or after logging the driver into the on-board recorder. The biometrics include one or more of facial scanning, fingerprint recognition and/or voice recognition.

According to another aspect, a method includes identifying a driver in a vehicle with a facial recognition feature of an on-board recorder, wherein the facial recognition feature includes matching a driver ID picture stored in a portable memory device with an image from a camera that is located on the vehicle.

Embodiments of this aspect may include one or more of the following features.

The method includes transferring the driver ID picture stored in the portable memory device to the on-board recorder, logging the driver into the on-board recorder after matching the driver ID picture with the image from the camera, uploading the image from the camera from the on-board recorder through an external network, and/or storing the image from the camera on the on-board recorder.

In another general aspect, a method includes automatically electronically capturing fuel purchase data, and electronically linking the fuel purchase data to vehicle mileage and location data.

Embodiments of this aspect may include one or more of the following features.

Automatically electronically capturing fuel purchase data includes automatically electronically capturing the fuel purchase data at a fuel pump, and electronically transferring the fuel purchase data from the fuel pump to a vehicle supplied fuel from the fuel pump.

Electronically transferring the fuel purchase data from the fuel pump to the vehicle includes transferring the fuel purchase data over a wireless connection. The wireless connection includes one or more of a WIFI connection, a BLUETOOTH connection, and an infrared connection. Alternatively, electronically transferring the fuel purchase data from the fuel pump to the vehicle includes transferring the fuel purchase data from the fuel pump to the vehicle using a portable memory device.

The fuel purchase data includes fuel-use tax data. The fuel purchase data includes data for the purchase of fuel selected from the group consisting of diesel, gasoline, gasohol, propane, and natural gas. The location data is acquired from a Global Positioning System and can be acquired at periodic intervals.

The vehicle mileage data is from at least one of a vehicle mileage sensing system and a vehicle engine control module. The vehicle mileage sensing system includes a speed sensor and a vehicle odometer. The vehicle mileage data is acquired at periodic intervals.

Electronically linking the fuel purchase data to vehicle mileage data and location data includes electronically processing the fuel purchase data, the vehicle mileage data, and the location data at periodic intervals. Processing at periodic intervals includes processing in response to receipt of location data for the vehicle from a Global Positioning System.

Each interval period has a predetermined duration and/or the same duration.

Electronically linking the fuel purchase data to the vehicle mileage data and the location data includes processing the fuel purchase data, vehicle mileage data, and location data for a vehicle to generate an International Fuel Tax Agreement report.

The fuel purchase data and fuel data includes fuel purchase data, vehicle mileage data, and location data for the vehicle. Processing of the fuel purchase data and the fuel data includes processing the vehicle mileage data and location data for the vehicle to create an International Fuel Tax Agreement (IFTA) log and processing the IFTA log and fuel purchase data to generate the IFTA report.

The IFTA log is processed on-board the vehicle. The IFTA log and fuel purchase data are processed to generate the IFTA report, which includes processing the IFTA log and fuel purchase data to generate the IFTA report at a host server external to the vehicle, e.g., the log is processed on-board, and a report is generated at a remote server.

Processing the vehicle mileage data and location data to create the IFTA log comprises processing the vehicle mileage data and location data at periodic intervals to create the IFTA log.

Processing the vehicle mileage data and location data to create the IFTA log includes processing the vehicle mileage data with time data to determine distance data.

Processing the vehicle mileage data and location data to create the IFTA log includes receiving a first location data for the vehicle; determining a first time data associated with the first location data; receiving a second location data for the vehicle; determining a second time data associated with the second location data, the second time data being subsequent in time to the first time data, in response to receipt of the second location data, calculating, using the vehicle mileage data, a distance traveled by a vehicle during the interval of time between the first time data and the second time data, recording the distance traveled, the second location data, and the second time data in the IFTA log.

Receiving a first location data and determining a first time data associated with the first location data includes receiving the first location data and the first time data from a Global Positioning System.

According to another aspect, a method includes receiving, through at least one of a wired or wireless connection, information from a fuel pump at an on-board computer of a vehicle that is supplied fuel from the fuel pump, the information including at least one of a price per fuel unit purchased, an amount of fuel tax paid, a type of fuel purchased, and a purchase amount paid for the fuel supplied to the vehicle.

Embodiments of this aspect may include one or more of the following features.

The fuel pump information includes location information for a place in which the fuel was supplied. The information sent to the fuel pump and/or received from the fuel pump can be transmitted through a wireless or wired connection. The wireless connection includes a WIFI connection and/or a BLUETOOTH connection. The fuel pump information can be transferred to or from a portable memory device, and then transferred to or from the on-board recorder or fuel pump. The portable memory device includes one or more of a smart card, a contact memory button, a transponder, or programmable logic controller, such as an electronically erasable, programmable, read-only memory (EEPROM) or flash EEPROM.

At least one of an identifier of the vehicle operator, a vehicle identifier, and/or an account identifier is transmitted between the fuel pump, a portable memory device and/or an onboard recorder.

Information from the on-board recorder is transmitted to the fuel pump, wherein the information includes at least one of a price per fuel unit purchased, an amount of fuel tax paid, a type of fuel purchased, and a purchase amount paid for the fuel supplied to the vehicle.

Transmitting the information from the on-board recorder to the fuel pump includes transmitting the information through use of a portable memory device to later transfer the information from the on-board recorder to the fuel pump.

According to another aspect, a method includes at least one of emitting and receiving a signal from a vehicle, the signal indicating whether a driver is alternatively in compliance or out of compliance.

Embodiments of this aspect may include one or more of the following features.

A signal is emitted indicating risk factors for the driver, wherein the risk factors are determined based on past driver records. A signal is emitted indicating an electronic license plate for the vehicle. The signal includes a bistate electronic signal, e.g., set to a first state if the driver is in compliance and set to a second state if the driver is out of compliance. The signal received from the vehicle is electronic.

According to another aspect, a method includes continuously emitting a bistate, driver related signal from a vehicle over a wireless network.

According to another aspect, a method includes querying a vehicle for a signal. The signal is a bistate signal and indicates whether a driver is alternatively in compliance or out of compliance. The bistate signal is set to a first state if the driver is in compliance and is set to a second state if the driver is out of compliance.

According to another aspect, a method for sharing a driver's hours of service includes transmitting driver hours of service data from an on-board recorder of a vehicle to law enforcement via at least one of a wired connection, a portable memory device, and a wireless network.

Embodiments of this aspect may include one or more of the following features.

A receiver under the control of law enforcement receives the hours of service data from the on-board recorder. The hours of service data is received at a receiver which is included in an electronic display tablet under the control of law enforcement. The electronic display tablet further includes a rechargeable battery. The electronic display tablet further includes a data port to communicate with an external device and a printer port. An hours of service graph is displayed on the electronic display tablet.

According to another aspect, a method for sharing a driver's hours of service includes displaying driver hours of service data on an electronic display tablet that is communicatively coupled to, but physically displaced from, an integrated on-board recorder of a vehicle.

Embodiments of this aspect may include one or more of the following features.

The electronic display tablet is flexibly tethered to the integrated on-board recorder to enable the tablet to be physically displaced from the integrated on-board recorder up to a maximum distance. The electronic display tablet is communicatively coupled to the integrated on-board recorder over a wireless connection.

According to another aspect, a method for identifying trailer location includes interfacing an on-board recorder with a trailer ID, and recording vehicle location and trailer ID on the on-board recorder.

Embodiments of this aspect may include one or more of the following features.

The on-board recorder or vehicle detects if a trailer is tethered to the vehicle. The on-board recorder is connected to a device located in the tethered trailer that contains the trailer ID. The trailer ID and driver related data is uploaded from the on-board recorder via an external network. A tethered trailer is detected, such as remotely from a remote server, by querying the on-board recorder for a specific trailer ID.

Date, time and/or change in trailer state, such as tethered or untethered from the vehicle, are recorded on the on-board recorder. The trailer ID, driver related data, location, date, time and/or trailer state are uploaded from the on-board recorder via an external network periodically, manually and/or responsive to a predetermined event.

The trailer contents are monitored with a sensor unit within or in the vicinity of the trailer. The sensor unit is configured for detecting a presence of one or more of a radiological substance, a biological substance, a chemical substance, and a hazardous material. Information relating to trailer contents monitored by the sensor unit is transmitted to the on-board recorder and/or through an external network remotely from the vehicle.

The information relating to the trailer contents is recorded on the on-board recorder. A warning is generated if the sensor unit detects one or more of the radiological substance, biological substance, the chemical substance and the hazardous material. Information relating to trailer contents is transmitted wirelessly by the sensor unit to one or more of the on-board recorder and a server external to the vehicle.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a front view of a display of an on-board recorder.

FIG. 2 is a schematic view of the on-board recorder.

FIG. 3 is a flowchart of a system and method for logging and reporting driver and vehicle operating data.

FIG. 4 is a flowchart of processing steps for logging and reporting driver and vehicle operating data.

FIG. 5 is a flowchart of processing steps for logging and reporting driver and vehicle operating data.

FIG. 6 is a graphical view of an hours-of-service log generated by the on-board recorder.

FIG. 7 is a front view of a display external to the recorder.

FIG. 8 is a schematic view of a device for receiving a signal indicating compliance status of a driver or vehicle.

### DETAILED DESCRIPTION

The systems, methods and apparatus described provide the capability of logging driver activity and vehicle operating data, creating reports from the data containing information required to comply with HOS laws or regulations and IFTA fuel tax reporting, and emitting a signal indicating whether the driver is in-compliance or out-of-compliance with applicable HOS laws or regulations.

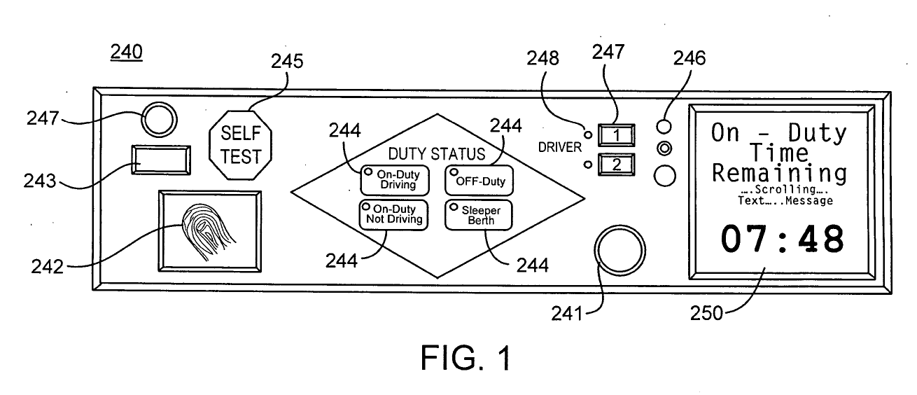

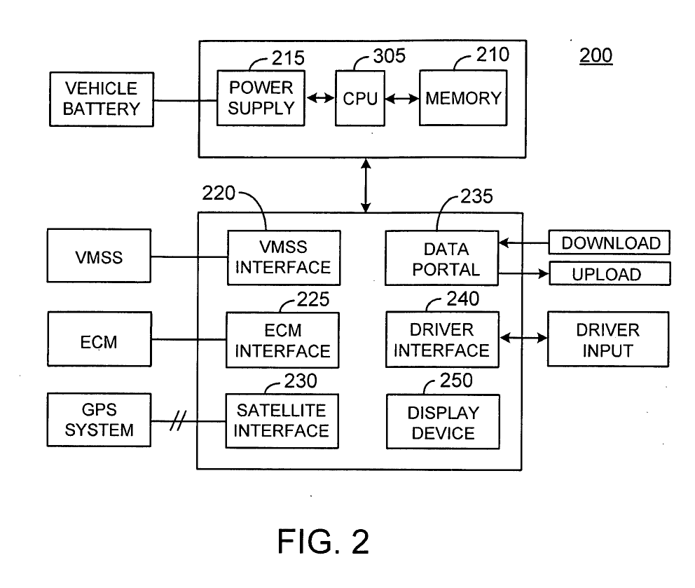

Referring to FIGS. 1 and 2, an on-board recorder 200 includes various inputs and outputs for interfacing with a driver of the vehicle, a host server (typically located at the fleet carrier), authorities, a vehicle mileage sensing system, for example, a speed sensor (such as a magnetic pickup) and vehicle odometer sensor display of the vehicle, a data bus of the vehicle, for example, the vehicle engine control module (ECM), and a global navigation satellite system. The driver communicates with recorder 200 via a driver interface 240 permitting data input and interaction with the driver through the use of a portable memory device reader 241, and duty status buttons 244.

Recorder 200 includes a front panel 240 having a display screen 250, for example, a scrolling text message bar, for displaying text messages to the driver, a portable memory device reader 241, such as a contact memory button reader or smart card reader, to permit logging-in and logging-out of the driver from recorder 200 as well as transfer of prior driver activity to and from recorder 200, and duty status buttons 244 permitting the driver to manually change the driver's duty status, i.e., “on-duty driving,” “off-duty,” “on-duty, not driving,” or “sleeper berth.”

Front panel 240 has a self-test button 245 that allows the driver to initiate testing of the operability of recorder 200, and an indicator light 246, 248, such as an LED light, that indicates proper or improper operation of recorder 200 and/or the driver that is currently driving when team driving. Additional indicating lights 246 provide a visual indication of whether the driver's hours of service is in compliance or out-of-compliance with applicable hours of service regulations, for example, a red light indicates out-of-compliance, a green light indicates in-compliance, and a yellow light indicates that the driver is approaching the end of permitted driving time. Additionally or alternatively, compliance information can be conveyed to the driver audibly and/or on display screen 250. Front panel 240 also includes either or both of on-duty time remaining and a scrolling text message bar on display 250. Driver buttons 247 permit recorder 200 to switch the display between the drivers driving.

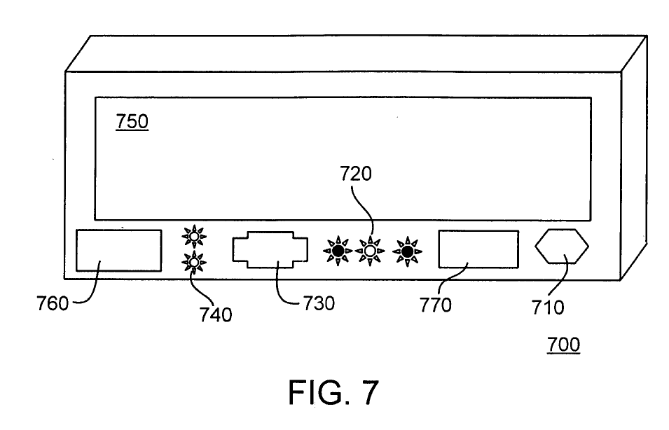

The front panel 240 of the driver interface includes optional biometric reading device(s) 242, 249, for example, a fingerprint recognition reader 242 and a camera 249. Recorder 200 also includes a wired data port 243, such as a USB port, to permit data transfer between the recorder 200 and other external devices or media, such as an electronic display (shown in FIG. 7). The recorder 200 can be sized and shaped so that it fits within a modular mounting system, e.g., a DIN slot of a vehicle dashboard, as discussed below.

Recorder 200 continuously obtains mileage from the vehicle mileage sensing system through a mileage sensing system interface 220, as well as mileage, engine use, miles driven, time and date obtained from the ECM through an ECM interface 225. Vehicle location (latitude and longitude), date, and time are input to recorder 200 from a global navigation satellite system, e.g., GPS, via a satellite interface 230 periodically, such as every fifteen minutes. In addition, a wireless data portal 235 is provided to permit the uploading and downloading of data from and to recorder 200.

On-board recorder 200 includes a back-up power supply 215, for example, an internal battery, processor 205, and a memory device 210. Primary power to on-board recorder 200 is provided by a connection to the vehicle battery. The processor 205 is, for example, a central processing unit (CPU) or a simpler data storage device utilizing encoded and encrypted instructions with processing capabilities in accordance with the available memory 210. The memory device 210 includes read and write capabilities and a variety of commercial, off the shelf memory media. The processor 205 and memory 210 collectively form the logic component of the recorder 200. Recorder 200 includes a display 250 for informing the driver of the remaining driving time permitted by the HOS laws or regulations, and for displaying relevant information to federal, national, state, provincial or local authorities, as discussed below.

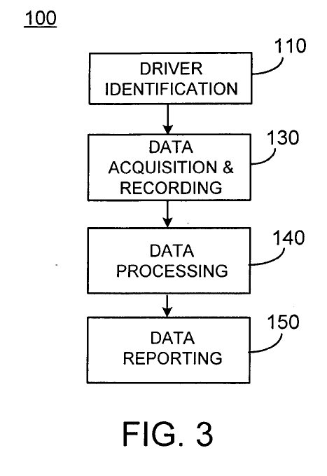

Referring to FIG. 3, a process 100 for logging and reporting driver activity and vehicle operating data includes driver identification 110, data acquisition and recording 130, data processing 140, and data reporting 150. On-board recorder 200 is always powered on. Recorder 200 can automatically enter a “sleep mode” in which non-essential systems such as the display screen are powered down to conserve power, and the driver can awaken recorder 200 by pushing any key, or recorder 200 can be awakened by starting the vehicle or if the vehicle moves. The ability of the driver to cause the unit to go into sleep mode or to power-off can be limited or prevented. The identity of the driver is determined by the use of a unique driver ID, for example, a portable memory device issued to the operator and operable with a portable memory device reader 241, such as a smart card or contact memory button. The ability to start, move, or disable the vehicle can be controlled by or contingent upon an accurate identification of the driver.

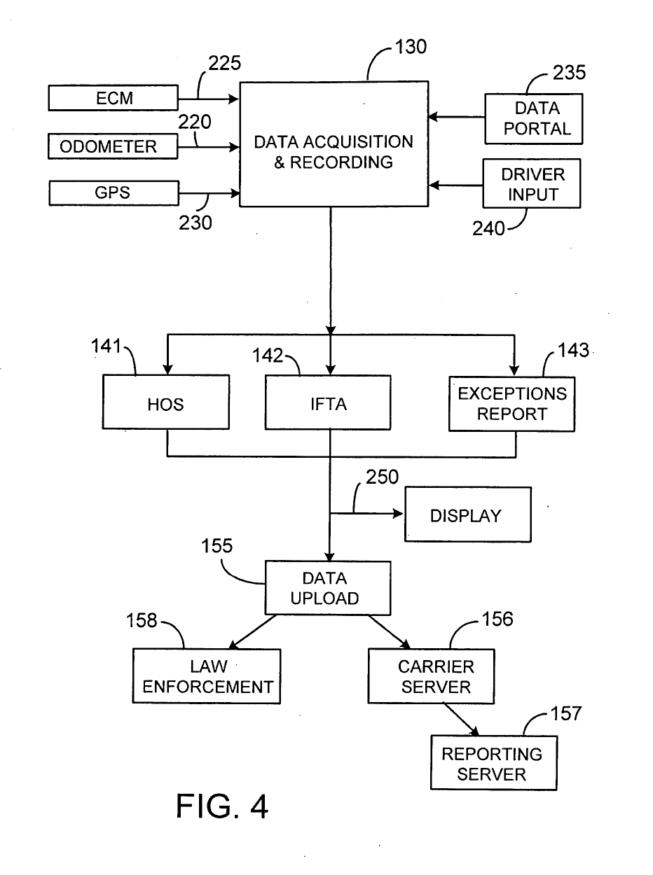

Referring to FIG. 4, data acquisition and recording 130 encompasses acquiring data from the vehicle mileage sensing system, the vehicle ECM, GPS, driver input, and data portal 235. The on-board recorder 200 is connected to the ECM of the vehicle through a data bus, such as an SAE J1708, J1850 or J1939 data bus connected through the ECM interface 225. The data on the bus is translated into an RS232 signal via a commercial off-the-shelf data translator and fed into the on-board recorder processor 205 and memory 210. The vehicle mileage sensing system interface 220 is formed, for example, by hard-wiring on-board recorder 200 to the vehicle's magnetic speed sensor. Recorder 200 includes a Global Positioning System (GPS) receiver which forms satellite interface 230 and derives its input signal from an antenna located on the interior or exterior of the vehicle.

Mileage can be determined from only the ECM or through a broadcasting of an odometer reading from a vehicle dashboard, such as on a SAE J 1708 MID 140 bus. Alternatively, data received from the vehicle mileage sensing system, such as a speed sensor positioned at the transmission tail shaft of a vehicle can be automatically calibrated, for example, by comparing the data to mileage determined from GPS or through GPS mapping from a central server. The device can be automatically re-calibrated, by programming recorder 200 with the size and wear of the vehicle's tires and/or for different gear ratios. Recorder 200 can then provide the calibrated mileage to at least one of the odometer display and the ECM. Vehicle mileage can also be calibrated by using the GPS mapping at the central server and then sending the calibration back to the vehicle.

Recorder 200 automatically, continuously records the vehicle operating data as raw vehicle operating data obtained from the vehicle mileage sensing system and the ECM, and records GPS data at a set period time, for example, every fifteen minutes. GPS data can also be recorded upon the detection of a specific event, such as a change in duty status, or operating parameter, such as the engine being off for more than a specified period of time. To determine the hours of service, the driver's duty status throughout the day is also determined. Duty status includes driving-on duty, not driving-on duty, off duty, and sleeper berth. Each change in duty status can be manually input to recorder 200 by the driver using duty status buttons 244 and recorded with a time and date stamp obtained via GPS. Certain changes in duty status can also be determined automatically by recorder 200, as discussed below.

Data processing 140 creates an HOS log 141 and an IFTA log 142 from the raw data, and compares the HOS log to applicable regulations to determine whether the driver is in-compliance with HOS regulations. A more detailed exceptions report can be created from the comparison of the HOS log to applicable regulations that provide the detail of the comparison. In creating the HOS log, recorder 200 continuously calculates the time the driver has been in each duty status over the course of a day. The HOS log includes the time per duty status for eight consecutive days, including a calculation of the total hours driven today, total hours on duty for the past seven days, and total hours on duty for the past eight days. The hours of service log is typically created from date, time, mileage and duty status.

In creating the IFTA log, at every acquisition of data from GPS, for example, every fifteen minutes, the miles driven over that time period are calculated from mileage data obtained from the vehicle mileage sensing system and/or ECM, and recorded with a location, time, and date stamp obtained from the GPS data. A fuel tax report is then created, preferably by an external server, such as the host server or a second server communicating with the host server, having the requisite software to create a report in compliance with IFTA regulations,. from the IFTA log and any required fuel purchase information. The IFTA fuel tax report can include all the required details of an IFTA compliant report, e.g., part 600 of the International Fuels Tax Agreement, or portions thereof.

Data processing 140 can also include an automatic determination of change in duty status from off-duty to driving on-duty. By recording the time when the vehicle starts to move, as determined by the ECM indicating engine use, i.e., that the vehicle has been started, and by the vehicle mileage sensing system or ECM indicating motion, recorder 200 automatically records a change of duty status to driving-on duty at that time. By recording the time when the engine is turned off for a predetermined period, such as four minutes, recorder 200 automatically prompts the driver to input a change of duty status to not driving-on duty, off duty, or sleeper berth. Also, by recording the time when the engine remains on but the vehicle is not moving (determined from, for example, either a speed of zero obtained from the ECM or there being no change in mileage) for a predetermined period, such as four minutes, recorder 200 can automatically prompt the driver to input a change of duty status to not driving-on duty, off duty, or sleeper berth. Off duty status is automatically determined at the time the driver logs out from recorder 200, for example, by removing the smart card from smart card reader 241. Alternatively, the driver can use the keys to indicate off-duty status while leaving the card in the reader.

Data reporting 150 includes using recorder 200 to provide information to the driver, as discussed above, e.g., by displaying on display device 250 the hours of service log and compliance status with display 250 and indicator lights 246. An additional display tablet can be connected to recorder 200 to display the hours of service log in grid form. For example, operator's total hours driven today, total hours on duty today, total miles driven today, total hours on duty for seven days, total hours on duty for eight days, and the operator's changes in duty status and the times the changes occurred are displayed.

Data reporting 150 also encompasses the ability of system 100 to automatically upload the hours of service log and the fuel tax log to a receiver external to the vehicle using a wireless telecommunications network. Recorder 200 also emits, such as periodically or continuously, a signal representative of the compliance status to a second receiver external to the vehicle and under control of authorities, such as law enforcement, carrier management, regulatory agencies or other approved inspector or agent. In addition, the compliance status, HOS logs or a more detailed exceptions report can be uploaded to a second receiver external to the vehicle when recorder 200 is queried.

Recorder 200 is configured to automatically attempt to transmit data to a host server via the wireless telecommunications network's off-peak hours, e.g., at a pre-determined period of time (e.g., 1:00 am-5:00 am) that is selected because it is available at low cost. A wireless telecommunications network made up of pager networks, cell phone networks and wide area networks provides low cost options. Other options are an infrared connection, a radio connection, and a satellite connection. Recorder 200 is programmed to seek a single wireless telecommunications network to upload data to a host server. Alternatively, recorder 200 can be programmed to seek various wireless telecommunications networks to upload data to a host server, from the least cost to the next most expensive cost and so on until the device finds such a data link and uploads its data. If after a predetermined time period for performing an upload, such as fourteen days, upload has not been successful, each day's HOS log, and IFTA log, and alternatively an exceptions report as well, can be uploaded whenever the recorder comes into contact with the pre-determined method of uploading data, or can be uploaded over a satellite connection. Data is stored on recorder 200 for not less than 14 consecutive days and is organized by driver for hours of service purposes and/or by vehicle for fuel tax reporting purposes.

By continuously emitting a signal indicating the compliance status of the driver, recorder 200 provides a way whereby authorized federal, state or local officials can immediately check the status of a driver's hours of service. Authorities receive this signal whenever the vehicle is within a predetermined range of the second receiver located, for example in a hand-held device, law enforcement vehicle, weigh station, or along a highway. The entire hours of service log can be displayed on recorder 200 or on an electronic display or tablet connected thereto, or downloaded, when recorder 200 is queried. Data can be downloaded to law enforcement personnel using a receiver tied to a computer, for example, in the law enforcement vehicle, that wirelessly interrogates recorder 200 and displays the data, by using a handheld device in the possession of a law enforcement officer that wirelessly interrogates recorder 200 and displays the data, or by using a wired connection through a port inside or outside of the vehicle.

The signal emitted from the vehicle and received externally from the vehicle, such as by law enforcement, can be any radio frequency signal that is continuously emitted, i.e., by a non-interrupted signal, or a rapidly pulsed signal. For example a signal having a short duration can be sent by a spread-spectrum technique or method, such as an Ultrawideband (UWB) signal having pulse widths on the order of approximately 0.2 to 10 ns and/or a signal with longer pulses, such as approximately 1 ms: Encoded signals can be distinguished by one or more of several methods of multiple access, including Code Division Multiple Access (CDMA) which encodes data with a certain code, Time Division Multiple Access (TDMA) which divides a channel up by time, and/or Frequency Division Multiple Access (FDMA) which divides up a channel by frequency. The signal can be a digital or analog signal that contains compliance status and/or an identifier providing any desired vehicle or driver related information within the data signal. For example, the signal can contain multiple signals or data packets that are emitted which indicate one or more of risk factors for the driver, wherein the risk factors are determined based on past driver records, and an electronic license plate for the vehicle. The signal itself can be a bistate electronic signal set to a first state if the driver is in compliance and set to a second state if the driver is out of compliance.

The receiver under the control of law enforcement which receives the hours of service data or compliance signal from the on-board recorder can include an electronic tablet 700. The electronic display tablet includes one or more of a rechargeable battery, a data port to communicate with an external device or a vehicle on-board recorder, and a printer port. The law enforcement receiver is therefore capable of displaying an hours of service graph on the electronic display tablet, such as during a roadside inspection. The electronic display table can be communicatively coupled to, but physically displaced from, an integrated on-board recorder of a vehicle or connected through a wired connection.

One or more of driver hours of service data, fuel tax or purchase data, vehicle related data, and/or driver related data can be uploaded according to a predetermined or driver selected data transmission process. For example, uploading driver hours of service data includes identifying available data transmission options with or via the recorder 200. The recorder 200 is programmed with instructions or code, such as within an internal memory device of the recorder, that provide multiple transmission options. A transmission option having the least cost, fastest transmission rate, or most reliable transmission rate is selected automatically or manually with or via the recorder 200. A least cost option can be selected based on pricing schedules programmed into the recorder, downloaded by the recorder or selected by the driver with the recorder, e.g., from a menu listing transmission options and costs. Parameters effecting the cost of transmission, and incorporated into the pricing schedules, can be programmed into the internal memory device. The parameters include one or more of data content, the location or geolocation of the data transmission, date of transmission, such as weekday or weekend, time of transmission, such as day, evening, peak or off-peak, transmission rate, e.g., baud rate, type of connection, e.g., wired or wireless connection to an external network, and/or type of network. The type of network available for data transmission includes selecting the least cost carrier among available cellular carriers or the least cost transmission type among available networks, such as cellular, satellite, pager, WIFI, broadband, analog or digital roaming, etc.

The recorder 200 is programmed to automatically and electronically determine available data transmission options, which may include identifying available data transmission time periods and/or available wireless networks, such as pager networks, cellular telephone networks, wide area networks, infrared communication networks, radio networks, and/or satellite network. Available data transmission options can include identifying multiple available data transmission options, such as three or more available data transmission options, and selecting the least cost data transmission option based on the pricing schedules stored in the memory device of the recorder 200 or provided remotely at a fleet server. If stored remotely at a fleet server, the recorder 200 can be updated periodically with data and/or software patches through the fleet server. If the transmission option is selected manually through the recorder, the driver can be provided with all transmission options and associated costs for each option in a list on a display, e.g., on a display of an electronic tablet connected wirelessly or directly to the recorder 200. For example, driver hours of service data is uploaded via a wireless network supporting the least cost data transmission option, e.g., transmitting 1.2 MB of data at 2:45 a.m. EST from interstate 81 in eastern Pennsylvania through a cellular telephone network using analog roaming through a specific cellular carrier. Other available data transmission options were cellular networks providing faster data transmission, but at a higher price and a satellite network at the most expensive data transmission price, e.g., $0.10 per message or kilobyte. U.S. Pat. No. 5,966,658, entitled “Automated Selection Of A Communication Path,” describes an exemplary system and process for automatically selecting a communication path based on various predefined parameters, the entire contents of which is incorporated by reference herein.

The recorder 200 can be programmed to transmit driver hours of service data, fuel tax or purchase data, vehicle related data, and/or driver related data through predetermined or selected data transmission options, such as the aforementioned least cost data transmission options. Vehicle related data can include one or more of measured engine parameters obtained through the ECM interface 225, tire pressure, fuel tank levels or vehicle speed. Driver related data can include one or more of a driver license information, biometrics, and/or driver record, such as data stored within a memory of the on-board recorder or a fleet server and relating to one or more of commercial driver licenses, driver history, driver identification and physical descriptions. Fuel tax or purchase data recorded with the on-board recorder can include fuel purchase price, purchase location, fuel tax paid, fuel type, and/or payment method. The fuel purchase can be for any number of fuel types, including diesel, gasoline, gasohol, propane, and/or natural gas fuel purchases.

The capability can also be provided to download information from a host server to the recorder. For example, using the communication link by which data is downloaded to the host server, the host server can also communicate data to recorder 200 at the end of the daily upload cycle. Data transmitted can include driver regime, such as 7 day/60 hour or 8 day/70 hour regime. The host server can also communicate with recorder 200 as desired via a wireless telecommunications network to ascertain information, such as compliance status, location as of the last GPS recording and remaining HOS. The recorder 200 can also receive operating software or data updates remotely from the server with patches sent over an external network. U.S. Pat. No. 5,699,275, entitled “System And Method For Remote Patching Of Operating Code Located In A Mobile Unit,” describes an exemplary process and code for updating a mobile unit remotely, the entire contents of which are incorporated by reference.

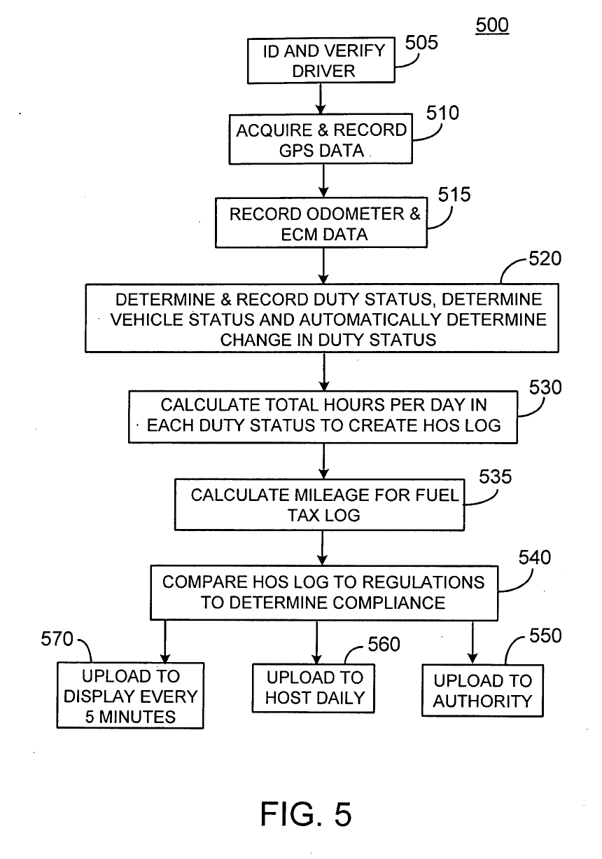

Referring to FIG. 5, the overall process includes driver and vehicle identification and verification 505, acquiring and recording GPS data at pre-determined intervals, for example, every 15 minutes 510, acquiring mileage and ECM data, for example, continuously, recording mileage and ECM data, for example, at least every 15 minutes, 515, determining duty status from driver input and/or automatically and recording duty status 520, calculating total hours per day in each duty status to create an HOS log 530, recording latitude and longitude for fuel tax reporting 535, comparing the HOS log to regulations to determine compliance, uploading compliance status or a detailed exceptions report to federal, national, state, provincial or local authorities 550 continuously, periodically or upon receipt of authority's or driver request, uploading to the host server 560, for example, daily, and uploading to the recorder display 570, for example, every five minutes.

Recorder 200 automatically records data formatted to meet home country legal requirements and country of operation legal requirements. For example, a driver whose home country is Mexico, may operate a vehicle over a period of time in the United States. The operation of the vehicle within these countries, and their respective states, provincial or local jurisdictions triggers different reporting requirements to comply with respective HOS laws or regulations. Recorder 200 simultaneously records hours of service and/or fuel tax information that is country-specific, such as for the United States, Canada, and Mexico, and has multi-lingual reporting capability, such as English, French and/or Spanish.

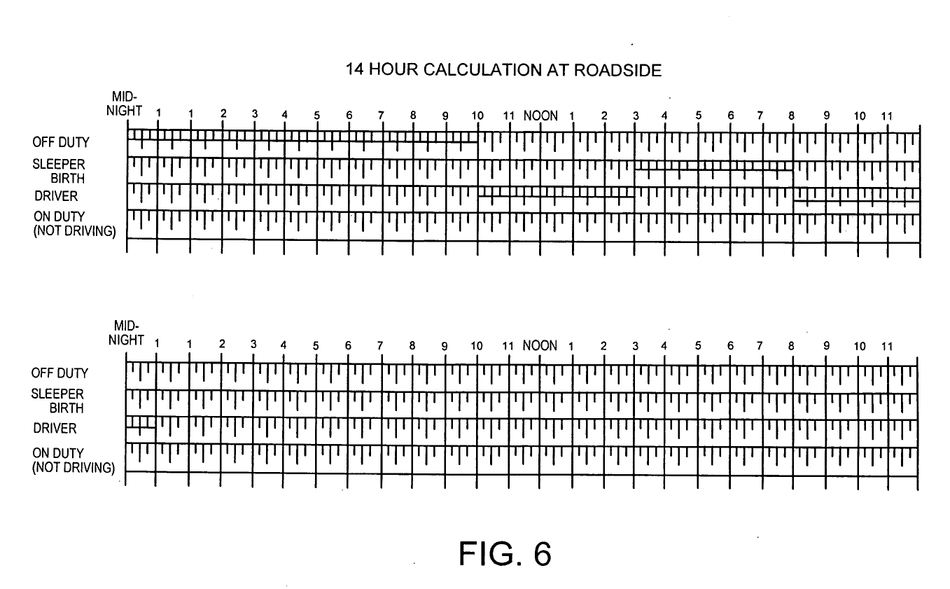

As seen in FIG. 6, a graphical representation of an hours of service log includes duty status (off-duty, sleeper berth, driving, and on duty-not driving) on the vertical axis, and hours of the day on the horizontal axis. The log line indicates each change in duty status, the time the change occurred, and the hours within each duty status between changes. In the example shown for Day 1, the driver was in “off duty” status for 10 hours (midnight to 10 am on Day 1), followed by five hours of on “duty-driving” (10 am to 3 pm on Day 1), followed by a “sleeper berth” period of five hours (3 pm to 8 pm). The driver was then back on duty “driving” for another five hours (8 pm to 1 am on Day 2) when the driver was pulled over for a routine roadside inspection or weigh station. In this situation, the driver was in compliance with the hours of service regulations. Accordingly, a signal representing a compliance status (in-compliance state) would have been emitted by the on-board recorder during the inspection. The law enforcement officer would have known before inspecting the hours of service log shown in FIG. 6 that the driver was already in compliance.

A complete display of an hours of service log can provide eight such graphical representations, one for each of the eight days, and a summary of the total hours driven today, total hours on duty for seven days and total hours on duty for eight days. As seen in FIG. 7, the hours of service log shown in FIG. 6 can be displayed separately from recorder 200. For example, an external display device 700 is connected to recorder 200 to provide a more detailed review of recorded data. External display device 700, such as an electronic tablet connected wirelessly or through a wired connection such as a USB connection with recorder 200, has a relatively large display 750 for viewing detailed HOS logs (see FIG. 6) that are not as easily viewed on the display 250 of recorder 200. The external display device 700 includes a device functioning indicator 710, compliance status indicators 720, a home or operating country selector 730, driver selectors or indicators 740, a duty status selector 760 and a data transmission port 770, such as a USB connection or wireless transceiver for wirelessly communicating with recorder 200.

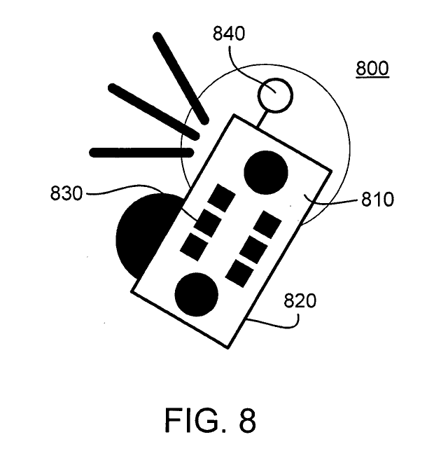

Referring to FIG. 8, a device 800 for receiving a signal indicating a compliance status of a driver or vehicle has an “in-compliance” indicator 810, an “out-of-compliance” indicator 820, an input/keypad 830, and a receiver 840 for receiving emitted compliance status signals from nearby recorders 200. Device 800 can be powered from a law enforcement officer's vehicle (such as plugged into a cigarette lighter), or battery, and can be a handheld device that is used to monitor passing and nearby vehicles for HOS compliance status. Recorder 200 can have a short range RF transmitter which broadcasts the driver's HOS compliance status, electronic vehicle license plate, drivers risk factor based on past records, etc. The receiver can be an RF receiver distributed to state, local, and federal authorities providing snapshot monitoring of the status of drivers (HOS compliant or non-compliant), high risk drivers and vehicles at toll gates and border crossings.

A number of embodiments of the invention have been described. Nevertheless, it will be understood that various modifications may be made without departing from the spirit and scope of the invention. For example, the on-board recorder may be configured to include one or more of the following features.

Recorder 200 can be sized and shaped to fit into a North American or European DIN slot in a vehicle dashboard, e.g., the width of the recorder faceplate 240 can be approximately 7 inches wide by approximately 2 inches high. A typical DIN slot, e.g., a Euro DIN receiver (or “E” fit) is the most common size of receiver for both car and marine applications. An “E” fit has a rectangular chassis that measures about 7″ wide by 2″ high (depths vary), and loads into the mounting surface from the front. DIN-size receivers slide into a metal or plastic sleeve that attaches to the front of the mounting location. The recorder 200 can be sized and shaped to fit into ISO-DIN slots, such as “I” and “J” slots, and/or DIN ½ and double DIN slots. The DIN slots can be configured to also house a cassette deck, CD player and/or the recorder 200.

Recorder 200 can support geofencing of the vehicle. The recorder 200 can be used to track or notify a driver, fleet server or law enforcement if a vehicle equipped with the recorder has entered a restricted area, e.g., such as a “No Through Trucks” roadway or other infrastructure where the vehicle is not permitted to travel. For example, the location information of the vehicle is monitored by the recorder 200 and the recorder provides a notification, e.g., visible or audible warning to the driver on the recorder or transmission of data to law enforcement or a fleet server, that a vehicle has entered a restricted area or deviated from a preferred travel area. Alternatively, a roadway designated as a “No Through Trucks” roadway can be equipped with a transmitter for emitting a signal. If a truck equipped with a recorder 200 passes within the vicinity of the transmitter, such as within 100 feet, the recorder will detect and record an indication of the vehicle's presence at the location. This data can be viewed locally at the vehicle, e.g., on demand during a roadside inspection, reported with a periodic data log sent by the recorder, e.g., at the end of a delivery, and/or reported through an upload to an external server tracking the data.

Recorder 200 can include a biometric reader for verifying the identity of the driver using, for example, facial, retinal or thumbprint recognition. The identity data is compared to a database within recorder 200 to verify the identity of the driver by matching the biometric with a specific driver. The unique driver ID can be a Transportation Worker Identification Card (TWIC) currently being developed by the Transportation Security Administration (TSA) or a commercial driver's license (CDL) issued by various state or federal governments. The vehicle can be disabled if the identity of the driver cannot be verified after some pre-determined time.

Camera 249 can be a miniature camera, such as with IR lighting for night driving, positioned on the front face of recorder 200 for visual analyzing the driver. The camera is used to identify the driver and visually tie the driver to the HOS data. Facial recognition, retinal or IRIS mapping, and driver behavior can be periodically assessed such as for drowsy driver syndrome from the recorder or an external source, such as through an external host server. The digital camera feature can be used for gate authorization by sending the drivers' ID and photograph ahead to a destination, such as a shipping dock or border crossing. The camera feature can be used for on-board documentation to the central server. Once the vehicle is in the non-moving and park mode the digital camera can also be used as a FAX/Scanner.

A biometric of a driver of a vehicle is obtained using the on-board recorder 200, and can include logging the driver into the on-board recorder, e.g., before, after or while obtaining the biometric and before recording hours of service data and/or fuel tax reporting data. The biometric of the driver can be verified using the on-board recorder with a reference biometric of the driver, e.g., a reference biometric of the driver stored on the on-board recorder, a portable memory device and/or on a server remote from the on-board recorder.

The biometric of the driver is obtained periodically, randomly, or responsive to a predetermined event, e.g., manually initiated, upon switching drivers, responsive to change in duty status or change in operating state of the vehicle or engine. The biometrics, including the reference biometric, are stored on the on the on-board recorder, and/or uploaded from the on-board recorder through an external network. The biometric of the driver can be obtained as an integral step in logging in the driver to the recorder 200. The biometrics can be obtained with one or more of facial or retinal scanning, fingerprint recognition and/or voice recognition to acquire facial scans, fingerprints, and/or voice samples.

For example, a driver in a vehicle is first identified with a facial recognition feature of the on-board recorder by matching a driver ID picture stored in a portable memory device with an image from the camera 249 that is located on the vehicle. The reference driver ID picture stored in the portable memory device is transferred to the on-board recorder, e.g., while logging the driver into the on-board recorder. After matching the reference driver ID picture with the image from the camera 249, the image from the camera 249 is uploaded from the on-board recorder through an external network, and/or is stored on the on-board recorder.

The portable memory device carried by the driver, for example, the smart card or contact memory button (such as the IBUTTON™ available from Dallas Semiconductor Corp.), can be configured to retain driver identity data, driving regime (such as, 7 day or 8 day regime), and the driver's hours of service log such that this information is automatically downloaded from the portable memory device to recorder 200 whenever a driver logs into a vehicle. In this way, the driver's hours of service log and related information can be transferred from one vehicle to another as the driver changes vehicle. Such data can also be downloaded into recorder 200 from the fleet carrier via several methods, for example, a wired connection at the fleet terminal, a wireless connection at the fleet terminal and/or a wireless download at any location within the range of a wireless telecommunications network. The portable memory device can include a programmable logic controller, such as an electrically erasable, programmable, read-only memory (EEPROM) of flash EEPROM.

Additional information that can be stored on the portable memory device includes the driver's current driving regime, the commercial driver license number (CDL #), commercial driver endorsements (e.g., HAZMAT), traffic violations and high risk driver data (e.g., DWI convictions). Transactions such as the last vehicle driven can also be stored on the driver card. Portable memory device technology, such as the IBUTTON™, can be used to transfer fuel purchase information about the vehicle and/or driver to a fuel pump and/or from the fuel pump to recorder 200. Alternatively, or in combination, infrared and RFID technology can be used to transfer data to and from recorder 200 to a user ID card or other external data source.

For example, the recorder 200 and/or portable memory device can be used to automatically and electronically capture fuel purchase data, and electronically link the fuel purchase data to vehicle mileage and location data. The fuel purchase data is captured at or in the vicinity of a fuel pump during a fuel purchase. Alternatively, the fuel purchase data can be collected by a remote server from the fuel pump and later transmitted to the recorder 200. The fuel purchase data can be transmitted from the fuel pump to a vehicle supplied fuel from the fuel pump indirectly, e.g., with a portable memory device or through a wired or wireless connection to the fuel pump. A wireless connection can include one or more of a WIFI connection, a BLUETOOTH connection, and an infrared connection.

The portable memory device can include one or more of a smart card, a contact memory button, a transponder, or programmable logic controller, such as an electronically erasable, programmable, read-only memory (EEPROM) or flash EEPROM. The portable memory device can include an identifier of the vehicle operator, a vehicle identifier, and/or an account identifier transmitted between the fuel pump, the portable memory device and/or the recorder.

The SPEEDPASS™ system, offered by ExxonMobil® retail locations, represents an example of a wireless fuel purchase system that is currently available for tracking and permitting fuel purchases. SPEEDPASS™ is similar to other technology successfully used by tollgates which use an electronic system located in the pump or register to communicate with a portable device, such as a transponder. The electronic pump system and the transponder together provide access to gasoline, food and merchandise purchases by permitting purchases to a credit card or check card in the possession of the consumer. The SPEEDPASS™ system provides the pump system with a dedicated and personalized transponder identification code authorizing purchases. The user's account information and/or fuel purchase information is not stored within the transponder. However, a portable memory device used in conjunction with the aforementioned recorder 200 can provide the purchase convenience of systems such as the SPEEDPASS™ system, with the added or alternative benefits of capturing or storing fuel purchase information, account data, etc. for subsequent transfer to a vehicle on-board recorder 200. Alternatively, the wireless communication between the fuel pump system can occur directly between the recorder 200 and the pump.

The fuel purchase data can be electronically linked in the recorder 200 or at a remote server with other data, such as hours of service data, vehicle mileage data, vehicle or driver related data and location data acquired from a Global Positioning System at periodic intervals. The vehicle mileage data can be obtained from a vehicle mileage sensing system and/or a vehicle engine control module. The vehicle mileage sensing system includes a speed sensor and a vehicle odometer. The vehicle mileage data is acquired at periodic intervals, e.g., each interval period has a predetermined duration and/or the same duration. For example, the fuel purchase data is electronically linked to the vehicle mileage data and the location data. The fuel purchase data, vehicle mileage data, and location data for a vehicle are processed to generate an International Fuel Tax Agreement log or report.

The IFTA log is processed periodically on-board the vehicle or at a remote server, such as a fleet server. Processing the vehicle mileage data and location data to create the IFTA log includes receiving a first location data for the vehicle; determining a first time data associated with the first location data; receiving a subsequent second location data for the vehicle; determining a second time data associated with the second location data in response to receipt of the second location data; calculating, using the vehicle mileage data, a distance traveled by a vehicle during the interval of time between the first time data and the second time data; and recording the distance traveled, the location data, and the time data in the IFTA log.

U.S. Pat. No. 5,694,322, entitled “Method And Apparatus For Determining Tax Of A Vehicle,” and U.S. Pat. No. 5,970,481, entitled “Method And Apparatus For Determining Tax Of A Vehicle,” describe exemplary methods and apparatus for calculating vehicle fuel tax, the entire contents of each or which are incorporated by reference. The recorder 200 can be configured to include operating instructions and code to process vehicle position data, fuel purchase data, and/or fuel tax information in accordance with the IFTA of individual member states or countries.

Recorder 200 can separately record each driver's duty status when more than one driver is driving the vehicle, for example team driving. While the hours of service for a particular driver are transferred, for example, by a wireless telecommunications network connection or portable memory device, when the driver moves to a new vehicle, the IFTA logs, which are vehicle dependent, remain with the recorder on the old vehicle.

IFTA reports identify the miles driven in each jurisdiction. Border crossings, for example, between states, countries, and provinces, can be determined by the driver inputting to recorder 200 when a border is crossed, by mapping software on an external server, or by mapping software on recorder 200. Such border crossings may also be determined by geofencing. Recorder 200 can emit a signal indicating whether the driver is in-compliance or out-of-compliance with applicable IFTA laws or regulations, and other laws or regulations, such as tire pressure regulations.

For each change of duty status, whether input manually or determined automatically, location as determined by GPS can be recorded. If a vehicle is equipped with an Intelligent Dash Board with speedometer, on dash odometer and fuel gage 225, data can be collected by recorder 200 from the Intelligent Dash Board rather than through the vehicle mileage sensing system interface 220.

The data processing 140 and data reporting 150 sections can also provide the capability of data encryption to ensure data integrity and to prevent tampering by the vehicle operator. However, the driver and/or carrier can be permitted to modify the operating data, and the processor includes a track changes function that records any alterations of operating data. Recording 200 can also provide the capability of authenticating the recipient of data such that data is only available to authorized users.

Recorder 200 can prompt the driver to review and verify that all entries are accurate prior to uploading data to the carrier. Recorder 200 can further prompt the driver to certify that all entries made by the driver are true and correct or that recorder 200 is operating properly. If recorder 200 malfunctions, the recorder can notify the driver visually, audibly and/or using a text message, prompt the driver to revert to a paper log, and/or emit an out-of-compliance signal. If recorder 200 determines that the vehicle is moving but no driver is logged on, a visual/audio/or text warning is provided to the driver signaling that the driver is not logged-in, and an out-of-compliance signal is emitted. Recorder 200 can also warn the driver when the driver is approaching the maximum limitations established by the hours of service laws or regulations. Recorder 200 can also upload such a warning to the carrier.

To limit “double counting,” whereby a driver uses a paper log book when recorder 200 is on-board, recorder 200 can emit a signal indicating that recorder 200 is on-board the vehicle. Recorder 200 has logic built in to account for, for example, gaps in miles or time to ensure the driver does not tamper with recorder 200, such as by disconnecting the power source, pulling a fuse, or similar tampering.

Recorder 200 continually or periodically performs self-testing and can prompt the driver to troubleshoot for system errors and system rebooting. Recorder 200 can self-test upon demand from law enforcement.

WIFI™ or BLUETOOTH™ technology can be utilized to facilitate data transfer and/or permit the communication of many different devices to form a communication network. BLUETOOTH™ technology can be used to permit the downloading of fuel purchase information to recorder 200 and/or as the communication protocol for the recorder itself in communications with law enforcement or any other data transfer.

Recorder 200 can have a short range RF transmitter which broadcasts the driver's HOS compliance status, electronic vehicle license plate, driver's risk factor based on past records, etc. The receiver can be an RF receiver distributed to state, local, and federal authorities for a snapshot monitoring status of drivers (HOS compliant or non compliant) high risk drivers and vehicles at toll gates and border crossings, and for Homeland Security purposes generally. The receiver can plug into the cigarette lighter of the law enforcement vehicle, similar power source or be positioned within a handheld device. A non-compliant driver can be identified by recorder 200 emitting short range signals, such as 315 MHZ or 434 MHZ (approximately 200 ft) RF signals, which can be detected by authorities. The receiver held by authorities can be a 315 MHZ or 434 MHZ RF device. The data exchange is dependent upon an authentication process, whereby only authorized users (the authorities) can access the data. The authorities can then be alerted while driving past a vehicle on the highway or when sitting along an interstate and monitoring for violators. Once a violation has been detected the authorities can obtain a detailed log from the recorder via a hard connection or a wireless connection, such as BLUETOOTH™ OR WIFI™ adapter in the USB data port of recorder 200. Also the non compliant driver status can be broadcasted on the SAE J1708/1587 data bus and the RS-232 port from the recorder. As another method the RS-232 and/ or SAE J1708 data can allow existing telecommunication products on the vehicle such as QUALCOMM™, XATA™ and PEOPLENET™ to transmit the driver log report status. Also, as another method the RS232, SAE J1708 or USB data port can allow the driver logs to be downloaded via WIFI™ or BLUETOOTH™ adapters or devices at WIFI™ hot spots at truck stops, for example, SIRICOMM™ has incorporated WIFI™ hot spots at Pilot Service Centers, and WIFI™ Hot(s) Networks are planned at weigh stations, toll gates, and Fleet Terminals.

Vehicles emitting an in-compliance signal can pass through a checkpoint or roadside inspection without further delay and those that are not in-compliance can be stopped for further investigation. Recorder 200 can be queried to generate a driver's hours of service graph and display the graph, for example, on a display tablet that can be connected to recorder 200. Electronic tablet 700 can be equipped with a rechargeable battery, such as a NiCd battery or a standard NiCad battery pack used on video cameras. The electronic tablet device 700 can include an antenna for all types of wireless communication and a connection permitting wired communication. The electronic tablet 700 can include a USB port so that printers and other devices can communicate to the electronic table 700 to create a virtual office, e.g., payroll information, processing and/or generation of required reports or permits can be facilitated through a printer connection integrated with the electronic tablet 700 or recorder 200. The recorder can be provided with a USB Port to form a direct, non-wireless connection to the tablet. The recorder and/or the electronic table can be configured to include software or operating instructions for processing payroll information and/or for receiving and authorizing the issuance of vehicle or cargo permits.

Recorder 200 can also be provided with the option of detecting whether or not a trailer is tethered to the vehicle. If tethered, recorder 200 connects to a PLC chip located in the trailer from the ABS Trailer Module that contains the trailer's ID number and related data and a PLC receiver chip located in the recorder. The trailer ID information can be obtained from various sources, for example, via a PLC4 Trucks power line communications, such as defined in SAE J2497. If the fleet operator wants to locate that particular trailer it can access the PLC network chip via cell or pager network, or via satellite, through recorder 200.

Trailer location can be determined with or through the on-board recorder. For example, if an on-board recorder is in wired or wireless communication with a device contained within a trailer and storing a trailer ID, the vehicle location and trailer ID can be stored on the on-board recorder. The on-board recorder is then used to detect if a trailer is tethered to the vehicle, and a person residing in a fleet office can query a vehicle's on-board recorder to determine the status of a trailer connected to the vehicle. The trailer ID and driver related data can be automatically uploaded from the on-board recorder via an external network on a periodic or requested basis. A tethered trailer can alternatively be detected by the recorder, such as remotely from a remote server, by querying all on-board recorders within a network for a specific trailer ID.

Various parameters, e.g., date, time and/or change in trailer state, such as tethered or untethered from the vehicle, are recorded on the on-board recorder. The trailer ID, driver related data, location, date, time and/or trailer state are uploaded from the on-board recorder via an external network periodically, manually and/or responsive to a predetermined event. The trailer contents can be monitored with a sensor unit within or in the vicinity of the trailer and information relating to the contents stored on the recorder 200. The sensor unit can be any device configured for detecting a presence of one or more of a radiological substance, a biological substance, a chemical substance, and a hazardous material. Information relating to trailer contents is transmitted, e.g., wirelessly, by the sensor unit to one or more of the on-board recorder and a server external to the vehicle. If transmitted to the external server, the information relating to trailer contents can be transmitted directly or indirectly, e.g., through the recorder 200, to the external server. A warning is generated if the sensor unit detects one or more of the radiological substance, biological substance, the chemical substance and the hazardous material.

The Recorder 200 can be equipped with a Tractor PLC ID transmitter chip and the driver log information can be downloaded from a Trailer Tracking System, such as TERION™, using a SAE J 2497 power line communication protocol. This method allows the driver's log report along with a tractor ID to be sent through an existing power line, for example, using a standard SAE J560 tractor/trailer connector and SAE J2497 protocol to a trailer communication wireless product. U.S. Pat. No. 5,905,433, entitled “Trailer Communications System,” and U.S. Pat. No. 5,999,091, entitled “Trailer Communications System,” each describe exemplary tractor and trailer wireless communication processes and systems responsive to predetermined events or conditions, the entire contents of each of which are incorporated by reference.

Accordingly, other embodiments are within the scope of the following claims.

What is claimed is:

1. A least cost method of uploading driver hours of service data, comprising:
determining, with an on-board recorder, available data transmission options; and
uploading driver hours of service data via a wireless network with a least cost data transmission option.

2. The method of claim 1, wherein determining available data transmission options comprises identifying available data transmission time periods.

3. The method of claim 1, wherein determining available data transmission options comprises identifying available wireless networks.

4. The method of claim 2, wherein determining available data transmission options comprises identifying available wireless networks.

5. The method of claim 4, wherein available wireless networks comprise at least one of the networks selected from the group consisting of a pager connection; a cellular telephone connection; a wide area network connection; an infrared connection; a radio connection; and a satellite connection.

6. The method of claim 1, wherein determining available data transmission options includes identifying at least three available data transmission options.

7. A least cost method of uploading driver hours of service data, comprising:
electronically determining available data transmission options and an associated transmission cost for each data transmission option; and
uploading driver hours of service data via a wireless network with the least cost data transmission option.

8. The method of claim 7, wherein electronically determining includes using the fleet server to determine available methods or associated costs, downloading a pricing plan for available option to an on-board recorder, and referring to a pricing plan stored on the on-board recorder or at fleet server.

9. A least cost method of uploading driver hours of service data, comprising:
determining at least three available data transmission options for a vehicle on-board recorder and an associated cost for each available data transmission option; and
uploading driver hours of service data from the vehicle on-board recorder via a wireless network using the least cost data transmission option.

10. A least cost method of uploading vehicle location data, comprising:
determining, with an on-board recorder, available data transmission options; and
uploading vehicle location data via a wireless network with a least cost data transmission option.

11. A least cost method of uploading driver hours of service data, comprising:
electronically determining available data transmission options and an associated transmission cost for each data transmission option; and
uploading driver hours of service data via a wireless network with the least cost data transmission option.

12. A least cost method of uploading driver hours of service data, comprising:
determining at least three available data transmission options for a vehicle on-board recorder and an associated cost for each available data transmission option; and
uploading driver hours of service data from the vehicle on-board recorder via a wireless network using the least cost data transmission option.
